(19) United States
(12) Patent Application Publication
(10) Pub. No.: US 2011/0077337 A1
(43) Pub. Date: Mar. 31, 2011

(54) METHOD FOR PREPARING A HIGH THERMAL CONDUCTIVITY AND LOW DISSIPATION FACTOR ADHESIVE VARNISH FOR BUILD-UP ADDITIONAL INSULATION LAYERS

(76) Inventors: Yun-Chao YEH, Taoyuan Hsien (TW); Chung-Hao CHANG, Taoyuan Hsien (TW); Cheng-Nan YEN, Taoyuan Hsien (TW); Li-Hung LIU, Taoyuan Hsien (TW)

(21) Appl. No.: 12/567,255

(22) Filed: Sep. 25, 2009

(51) Int. Cl. C08K 3/34; C08K 3/28; C08K 3/38; C08K 3/22; C08K 3/14

(52) U.S. Cl. 524/404; 524/443; 524/428; 524/430; 524/433; 524/432; 524/437

(57) ABSTRACT

A method for preparing a high thermal conductivity and low dissipation factor adhesive varnish for build-up (combining) additional insulation layers is disclosed, where the adhesive varnish is used for high-density interconnected printed circuit boards or package substrates. The method comprises steps of: selecting at least two epoxy resins from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin; adding selected epoxy resins into a pre-treatment vessel with a certain ratio; heating and mixing them well to form an epoxy resin precursor; cooling the epoxy resin precursor; during the cooling process, adding a solvent to the epoxy resin precursor to adjust the viscosity of the epoxy resin precursor; adding a bi-hardener solution, a catalyst, a solvent, and a flow modifier and mixing them well with the epoxy resin precursor; adding an inorganic filler with high thermal conductivity and mixing it with the mixture in step (d) in vacuum to obtain a suitable viscosity value; and leaving the mixture in step (e) undisturbed for a period of time to form the high thermal conductivity and low dissipation factor adhesive varnish for build-up (combining) additional insulation layers.

### TECHNICAL FIELD

The present invention relates to a method for preparing a high thermal conductivity and low dissipation factor adhesive varnish for build-up (combining) additional insulation layers. The high thermal conductivity and low dissipation factor adhesive varnish for build-up (combining) additional insulation layers prepared by the method is advantageous in better thermal conductivity, better rheological property, better thermostability, low cost, and high yield, and is suitable to use in high-density interconnected printed circuit boards or IC-package substrates.

### BACKGROUND

Recently, with the rapid development in electronic technology, various kinds of high-technology industries spring up. Consequently, many more new electronic products with humanized design and functions are developed to replace conventional ones. These new electronic products are designed to be lighter, thinner, shorter, and smaller. Each of these new electronic products has at least one main board that is composed of many electronic elements and circuit boards. The function of the circuit boards is to hold the electronic elements, which are electronically interconnected with each other. Presently, the circuit boards are usually printed circuit boards.

Printed circuit boards can interconnect electronic elements with each other to perform an integral function. Therefore, they are integral parts to electronic information products. The quality of designed printed circuit boards will not only directly affect the reliability of electronic products, but also influence the competitiveness of the system products. Accordingly, printed circuit boards are commonly called “Mother of electronic system products” or “Basis of 3C industry”.

Nowadays, according to the technology for manufacturing commercial circuit boards, information computers are mainly made of fiberglass-based material containing copper foil substrates (FR-4), where the FR-4-s are immersed with flame resisting epoxy resin. The main advantages of FR-4 substrates include heat endurance, low dielectric constant, and being friendly to environment. In addition to having above features, high-frequency substrates are also advantageous in one aspect regarding dielectric loss. Recently, the best-known manufacturing process is a method using Resin Coated Copper (RCC) or a method of piling up laser drillable prepregs (LDPP). The method using RCC is first to coat a layer of dielectric layer onto the copper foil treated with roughening treatment and then bakes the copper foil to semi-solidified stage (B-stage). The copper foil is cut into desired sized pieces. Finally, the pieces are piled up and then the pile is pressed. The method of piling up LDPP is first to have fiberglass layers immersed in glue and then bake it to B-stage. After that, pile up above fiberglass layers and press the pile. Finally, cut the pile into suitable sized pieces.

However, the method using RCC or the method of piling up LDPP still has following shortcomings.
1. Because no carrier is used in the method using RCC, the flexibility is thus decreased. Consequently, the produced printed circuit boards become more brittle and may be easily damaged or detached so as to result in adhesive shortage. Besides, holes cannot be fully filled because resin has poorer flow-ability. Moreover, the utilization of the rolled up Resin Coated Copper becomes lower so as to elevate the cost greatly.
2. The method of piling up LDPP is unable to control evenly the thickness of dielectric layer. Therefore, it is required to use fiberglass layers processed with special treatment (laser drillable fiberglass layers). It will elevate cost greatly when signal transmittance is still incomplete.
3. When the method using RCC or the method of piling up LDPP is used, the yield of printed circuit boards is decreased because the resin scraps are easily detached.
4. It is usually unable to fill the holes and coat the surface (or add layers) at the same time because the contained resin in the method using RCC or the method of piling up LDPP is limited.

In order to overcome the shortcomings of the method using RCC or the method of piling up LDPP that have been already known to the public, inventor had the motive to study and develop the present invention. After hard research and development, the inventor invents a preparing method that is capable of controlling the thickness of dielectric layer and filling holes more fully and is of lower cost.

### SUMMARY OF THE DISCLOSURE

An object of the present invention is to provide a simple and low-cost method for preparing a high thermal conductivity and low dissipation factor adhesive varnish for build-up (combining) additional insulation layers.

In order to achieve above object, the present invention provides a method for preparing a high thermal conductivity and low dissipation factor adhesive varnish for build-up (combining) additional insulation layers. The method comprises following steps:
step (a). selecting at least two epoxy resins from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin;
step (b). adding selected epoxy resins in step (a) into a pre-treatment vessel with a certain ratio; heating and mixing them well to form an epoxy resin precursor;
step (c). cooling the epoxy resin precursor; during the cooling process, adding a solvent to the epoxy resin precursor to adjust the viscosity of the epoxy resin precursor;
step (d). adding a bi-hardener solution, a catalyst, a solvent, and a flow modifier and mixing them well with the epoxy resin precursor in step (c);
step (e). adding an inorganic filler with high thermal conductivity and mixing it with the mixture in step (d) in vacuum to obtain a suitable viscosity value; and
step (f). leaving the mixture in step (e) undisturbed for a period of time to form the high thermal conductivity and low dissipation factor adhesive varnish for build-up (combining) additional insulation layers.

In practice, the heating in step (b) is undertaken in condition of 80˜130° C./2˜8 hours. In step (c), the cooling is to lower the temperature below 100° C. and the viscosity of the epoxy resin precursor is adjusted to be 3,000˜10,000 cps.

In practice, the bi-hardener solution is formed by mixing an amine hardener and an acid anhydride hardener. The catalyst is an Imidazole catalyst; the flow modifier is an acrylic acid copolymer, an modified acrylic acid copolymer, or Poly-acrylates; and the inorganic filler with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate; and the solvent is selected from a group including dimethyl formamide (DMF), dimethyl cyclohexylamine (DMCA), methyl ethyl ketone (MEK), and cyclohexanone.

In practice, the viscosity in step (e) is controlled in a range of 5,000˜30,000 cps, where the viscosity is controlled by adding a dilute.

In practice, the time for leaving undisturbed the mixture in step (f), i.e. the gel time, is controlled to be between 200˜800 seconds (based on IPC-TM-650 test method).

The following detailed description describe with examples or embodiments for best understanding accompanying in conjunction with the drawings.

### BRIEF DESCRIPTION OF THE DRAWINGS

FIG. 1 is a flowchart showing steps in one embodiment of a method for preparing a high thermal conductivity and low dissipation factor adhesive varnish for build-up (combining) additional insulation layers of the present invention.

### DETAILED DESCRIPTION

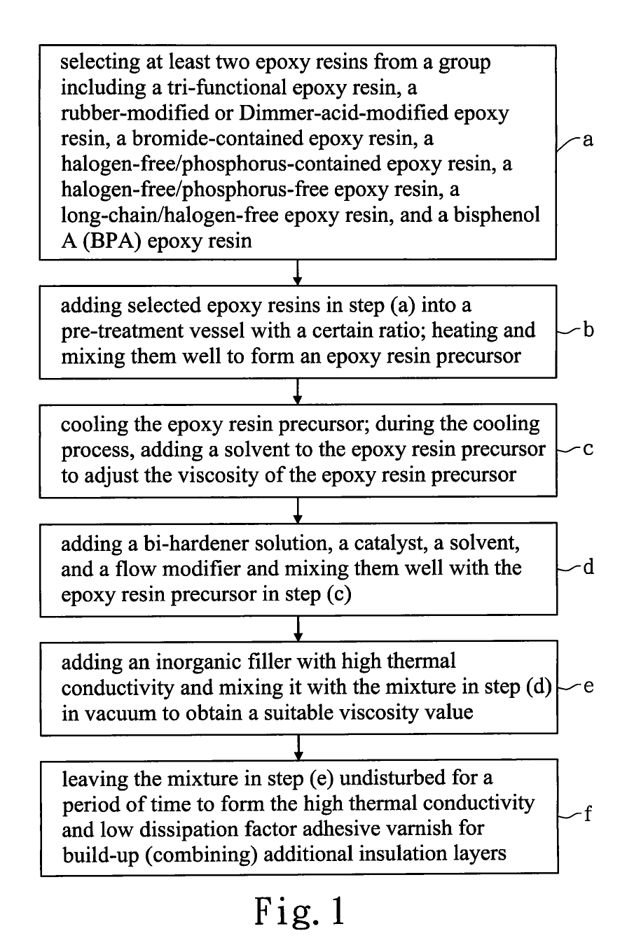

Please refer to FIG. 1, a flowchart showing steps in one embodiment of a method for preparing a high thermal conductivity and low dissipation factor adhesive varnish for build-up (combining) additional insulation layers according to the present invention. The adhesive varnish is to use in high-density interconnected printed circuit boards or IC-package substrates. The method comprises following steps:
step (a). selecting at least two epoxy resins from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin;
step (b). adding selected epoxy resins in step (a) into a pre-treatment vessel with a certain ratio; heating and mixing them well to form an epoxy resin precursor;
step (c). cooling the epoxy resin precursor; during the cooling process, adding a solvent to the epoxy resin precursor to adjust the viscosity of the epoxy resin precursor;
step (d). adding a bi-hardener solution, a catalyst, a solvent, and a flow modifier and mixing them well with the epoxy resin precursor in step (c);
step (e). adding an inorganic filler with high thermal conductivity and mixing it with the mixture in step (d) in vacuum to obtain a suitable viscosity value; and
step (f). leaving the mixture in step (e) undisturbed for a period of time to form the high thermal conductivity and low dissipation factor adhesive varnish for build-up (combining) additional insulation layers.

The heating in step (b) is undertaken in condition of 80˜130° C./2˜8 hours. In step (c), the cooling is to lower the temperature below 100° C. and the viscosity of the epoxy resin precursor is adjusted to be 3,000˜10,000 cps. Besides, the viscosity in step (e) is controlled in a range of 5,000˜30,000 cps and can be controlled by adding a dilute.

Moreover, the bi-hardener solution is formed by mixing an amine hardener and an acid anhydride hardener. The catalyst is an Imidazole catalyst. The flow modifier is an acrylic acid copolymer, a modified acrylic acid copolymer, or Poly-acrylates. The inorganic filler with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate. The solvent is selected from a group including dimethyl formamide (DMF), dimethyl cyclohexylamine (DMCA), methyl ethyl ketone (MEK), and cyclohexanone.

Accordingly, when in practice, as shown in table 1, following five kinds of epoxy resins are selected first: tri-functional epoxy resin 10 phr, bisphenol A epoxy resin 30 phr, long-chain/halogen-free epoxy resin 5 phr, bromide-contained epoxy resin 30 phr, and rubber-modified or Dimmer-acid-modified epoxy resin 25 phr. These selected epoxy resins are then added into a pre-treatment tank and are heated and well mixed to form an epoxy resin precursor. The epoxy resin precursor obtained above is then cooled. During the cooling process, a solvent is added to the epoxy resin precursor and the viscosity of the epoxy resin precursor is adjusted to a certain value. The epoxy resin precursor with adjusted viscosity is then well mixed with bi-hardener mixture 2.5 phr, Imidazole catalyst 0.25 phr, flow modifier (Acrylic acid copolymer (or Poly-acrylates) 2 phr), and solvent (Dimethyl formamide 20 phr). Then, the inorganic filler with high thermal conductivity (silicon nitride 20 phr, aluminum oxide 40 phr, and silicon oxide 40 phr) is added to be mixed with above mixture in vacuum to obtain a suitable viscosity value. Finally, leaving undisturbed above mixture for a period of time (i.e. the gel time, controlled in a range of 200˜800 sec) to form high thermal conductivity and low dissipation factor adhesive varnish for build-up (combining) additional insulation layers. The viscosity of the adhesive varnish is 14,800 cps. The thermal conductivity of the cured adhesive varnish is 2.3 W/m-K and the dissipation factor thereof is 0.008 (@1 GHz).

TABLE 1

| | | phr (by weight) | |
|---|---|---|---|
| Epoxy resin precursor | Tri-functional epoxy | 10 | (4.4%) |
| | resin | | |
| | Bisphenol A epoxy resin | 30 | (13.3%) |
| | Long-chain/halogen-free | 5 | (2.5%) |
| | epoxy resin | | |
| | Bromide-contained | 30 | (13.3%) |
| | epoxy resin | | |
| | Rubber-modified or | 25 | (11%) |
| | Dimmer-acid-modified | | |
| | epoxy resin | | |
| Filler | Silicon nitride | 20 | (8.9%) |
| | Aluminum oxide | 40 | (17.8%) |
| | Silicon oxide | 40 | (17.8%) |
| Hardener | Bi-hardener mixture | 2.5 | (1.1%) |
| Catalyst | Imidazole catalyst | 0.25 | (0.1%) |
| Flow modifier | Acrylic acid copolymer | 2 | (0.9%) |
| | (or Poly-acrylates) | | |
| Solvent | Dimethyl formamide | 20 | (8.9%) |

| Gel Time | 200 | sec |
|---|---|---|
| Thermal conductivity | 2.3 | (W/m-K) |
| Dissipation factor (@ 1 GHz) | 0.008 | |
| Glass transition temperature Tg | 155° | C. |
| Thermal degradation temperature Td | 325° | C. |
| Level of flame retardation | V-0 | |
| Viscosity of the adhesive varnish | 14800 | cps |

Please refer to table 2. Users can select only two kinds of epoxy resins to form an epoxy resin precursor. For example, as shown in table 2, tri-functional epoxy resin (50 phr) and halogen-free/phosphorus-free epoxy resin (50 phr) are selected. Similar to the preparing process mentioned above, the two selected epoxy resins are added into a pre-treatment tank and heated and well mixed to form an epoxy resin precursor. The epoxy resin precursor is then cooled and the viscosity thereof is adjusted. The epoxy resin precursor with adjusted viscosity is well mixed with bi-hardener mixture 19 phr, Imidazole catalyst 0.5 phr, flow modifier (modified Acrylic acid copolymer (or Poly-acrylates) 1 phr), and solvent (Dimethyl formamide 3 phr). Above mixture is then mixed with inorganic filler with high thermal conductivity (aluminum nitride 50 phr, aluminum oxide 30 phr, and aluminum hydroxide 20 phr) in vacuum to obtain a suitable viscosity value. Leaving above mixture undisturbed for a period of time (i.e. the gel time, controlled in a range of 200˜800 sec) to form a high thermal conductivity and low dissipation factor adhesive varnish for build-up (combining) additional insulation layers. The viscosity of the adhesive varnish is 22,100 cps. The thermal conductivity of the cured adhesive varnish is 3.0 W/m-K and the dissipation factor thereof is 0.006 (@ 1 GHz).

TABLE 2

| | | phr (by weight) | |
|---|---|---|---|
| Epoxy resin precursor | Tri-functional epoxy | 50 | (22.4%) |
| | resin | | |
| | Halogen-free/phosphorus- | 50 | (22.4%) |
| | free epoxy resin | | |
| Filler | Aluminum nitride | 50 | (22.4%) |
| | Aluminum oxide | 30 | (13.4%) |
| | Aluminum hydroxide | 20 | (8.9%) |
| Hardener | Bi-hardener mixture | 19 | (8.5%) |
| Catalyst | Imidazole catalyst | 0.5 | (0.2%) |
| Flow modifier | Modified acrylic acid | 1 | (0.5%) |
| | copolymer | | |
| | (or Poly-acrylates) | | |
| Solvent | Dimethyl formamide | 3 | (1.3%) |

| Gel Time | 800 | sec |
|---|---|---|
| Thermal conductivity | 3.0 | W/m-K |
| Dissipation factor (@ 1 GHz) | 0.006 | |
| Glass transition temperature Tg | 171° | C. |
| Thermal degradation temperature Td | 365° | C. |
| Level of flame retardation | V-0 | |
| Viscosity of the adhesive varnish | 22,100 | cps |

According to the method disclosed by the present invention, it is able to prepare the high thermal conductivity and low dissipation factor adhesive varnish for build-up (combining) additional insulation layers. Therefore, the present invention has following advantages:
1. The adhesive varnish for build-up (combining) additional insulation layers prepared by the method according to the present invention is effective for greatly lowering the dissipation factor and is beneficial for keeping the completeness of signal transmittance.
2. The adhesive varnish for build-up (combining) additional insulation layers prepared by the method of the present invention has better thermal conductivity, rheological property, and thermostability.
3. By using the method according to the present invention, the preparation process can be effectively simplified and the material loss can be decreased when the yield is improved.

As disclosed in the above description and attached drawings, the present invention can provide a method for preparing a high thermal conductivity and low dissipation factor adhesive varnish for build-up (combining) additional insulation layers. It is novel and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A method for preparing a high thermal conductivity and low dissipation factor adhesive varnish for build-up (combining) additional insulation layers, where the adhesive varnish is used for high-density interconnected printed circuit boards or IC-package substrates; the method comprising steps of:
step (a). selecting at least two epoxy resins from a group including a tri-functional epoxy resin, a rubber-modified or Dimmer-acid-modified epoxy resin, a bromide-contained epoxy resin, a halogen-free/phosphorus-contained epoxy resin, a halogen-free/phosphorus-free epoxy resin, a long-chain/halogen-free epoxy resin, and a bisphenol A (BPA) epoxy resin;
step (b). adding selected epoxy resins in step (a) into a pre-treatment vessel with a certain ratio; heating and mixing them well to form an epoxy resin precursor;
step (c). cooling the epoxy resin precursor; during the cooling process, adding a solvent to the epoxy resin precursor to adjust the viscosity of the epoxy resin precursor;
step (d). adding a bi-hardener solution, a catalyst, a solvent, and a flow modifier and mixing them well with the epoxy resin precursor in step (c);
step (e). adding an inorganic filler with high thermal conductivity and mixing it with the mixture in step (d) in vacuum to obtain a suitable viscosity value; and
step (f). leaving the mixture in step (e) undisturbed for a period of time to form the high thermal conductivity and low dissipation factor adhesive varnish for build-up (combining) additional insulation layers.

2. The method for preparing a high thermal conductivity and low dissipation factor adhesive varnish for build-up (combining) additional insulation layers as claimed in claim 1, wherein the heating in step (b) is undertaken in condition of 80˜130° C./2˜8 hours.

3. The method for preparing a high thermal conductivity and low dissipation factor adhesive varnish for build-up (combining) additional insulation layers as claimed in claim 1, wherein in step (c), the cooling is to lower the temperature below 100° C. and the viscosity of the epoxy resin precursor is adjusted to be 3,000˜10,000 cps.

4. The method for preparing a high thermal conductivity and low dissipation factor adhesive varnish for build-up (combining) additional insulation layers as claimed in claim 1, wherein the bi-hardener solution in step (d) is formed by mixing an amine hardener and an acid anhydride hardener.

5. The method for preparing a high thermal conductivity and low dissipation factor adhesive varnish for build-up (combining) additional insulation layers as claimed in claim 1, wherein the catalyst in step (d) is an Imidazole catalyst; the flow modifier is an acrylic acid copolymer, an modified acrylic acid copolymer, or Poly-acrylates; and the inorganic filler with high thermal conductivity is selected from a group including silicon nitride (SiN), aluminum nitride (AlN), boron nitride (BN), silicon carbide (SiC), aluminum oxide (Al₂O₃), silicon oxide (SiO₂), magnesium oxide (MgO), zinc oxide (ZnO), beryllium oxide (BeO), aluminum hydroxide (Al(OH)₃), and aluminum silicate.

6. The method for preparing a high thermal conductivity and low dissipation factor adhesive varnish for build-up (combining) additional insulation layers as claimed in claim 1, wherein the viscosity in step (e) is controlled in a range of 5,000˜30,000 cps.

7. The method for preparing a high thermal conductivity and low dissipation factor adhesive varnish for build-up (combining) additional insulation layers as claimed in claim 1, wherein the viscosity in step (e) is controlled by adding a dilute.

8. The method for preparing a high thermal conductivity and low dissipation factor adhesive varnish for build-up (combining) additional insulation layers as claimed in claim 1, wherein the solvent is selected from a group including dimethyl formamide (DMF), dimethyl cyclohexylamine (DMCA), methyl ethyl ketone (MEK), and cyclohexanone.

9. The method for preparing a high thermal conductivity and low dissipation factor adhesive varnish for build-up (combining) additional insulation layers as claimed in claim 1, wherein the time for leaving the mixture in step (f) undisturbed is in a range of 200˜800 seconds.
